(19) United States
(12) Patent Application Publication
(10) Pub. No.: US 2024/0209994 A1
(43) Pub. Date: Jun. 27, 2024

(54) LED FILAMENT ARRANGEMENT

(71) Applicant: SIGNIFY HOLDING B.V., EINDHOVEN (NL)

(72) Inventor: TIES VAN BOMMEL, HORST (NL)

(21) Appl. No.: 18/285,885

(22) PCT Filed: Apr. 4, 2022
(86) PCT No.: PCT/EP2022/058875

§ 371 Date: Oct. 6, 2023

(30) Foreign Application Priority Data
Apr. 6, 2021 (EP) 21166997.3

(51) Int. Cl. F21K 9/232; F21Y 103/10; F21Y 107/30; F21Y 107/70; F21Y 113/17; F21Y 115/10

(52) U.S. Cl. CPC F21K 9/232; F21Y 2103/10; F21Y 2107/30; F21Y 2107/70; F21Y 2113/17; F21Y 2115/10

(57) ABSTRACT

The present invention relates to an LED filament arrangement (10) providing LED filament arrangement light (12), comprising: a first LED filament (14a) adapted to emit first LED filament light (16a); and a second LED filament (14b) adapted to emit second LED filament light (16b), wherein the first LED filament and the second LED filament are parallel, and wherein the first LED filament and the second LED filament are separated by a gap (28) and mechanically connected to each other by a plurality of spacers (30a-c) arranged between the first LED filament and the second LED filament.

### FIELD OF THE INVENTION

The present invention relates to an LED (light emitting diode) filament arrangement. The present invention also relates to an LED filament lamp comprising at least one such LED filament arrangement.

### BACKGROUND OF THE INVENTION

Incandescent lamps are rapidly being replaced by LED (light emitting diode) based lighting solutions. It is nevertheless appreciated and desired by users to have retrofit lamps which have the look of an incandescent bulb. For this purpose, one can simply make use of the infrastructure for producing incandescent lamps based on glass and replace the filament with LEDs emitting white light. One of the concepts is based on LED filaments placed in such a bulb. The appearances of these lamps are highly appreciated as they look highly decorative.

U.S. Pat. No. 10,767,816 discloses a light bulb apparatus including a light bulb shell, a bulb head, and a heat sink cup. The heat sink cup has a first end connected to the light bulb shell, and a second end connected to the bulb head. The light bulb apparatus includes a flexible filament and a central support. The flexible filament has a first terminal and a second terminal, and the central support provides a first electrode electrically connected to the first terminal and a second electrode electrically connected to the second terminal. The light bulb apparatus includes an expanding structure mechanically coupled to the central support, and includes a plurality of holding portions for holding the flexible filament.

CN208871526 (U) discloses an LED lamp filament with adjustable color temperature. The LED light source comprises a substrate and at least two LED chip sets fixed to the substrate, each LED chip set comprises a plurality of LED chips, the LED chip sets are connected in parallel, the total voltage drop of the different LED chip sets is different, and the different LED chip sets are coated with fluorescent powder layers with different color temperatures. In one embodiment in CN208871526 (U), the substrate is a double parallel metal substrate. At one end, the two parallel substrate portions of the double parallel metal substrate merge with each other. At the opposite end of the double parallel metal substrate, the two parallel substrate portions are connected by some U-shaped element.

### SUMMARY OF THE INVENTION

A filament like the double parallel metal substrate LED lamp filament in CN208871526 (U) may have limitations. For example, it may not be possible to (properly) arranged the filament in a helix or spiral configuration, which is a configuration that some LED filament bulbs have.

It is an object of the present invention to overcome this problem, and to provide an improved LED filament arrangement, which LED filament arrangement in particular can be arranged in a helix or spiral configuration.

According to a first aspect of the invention, this and other objects are achieved by an LED filament arrangement providing LED filament arrangement light, comprising: a first LED filament adapted to emit first LED filament light; and a second LED filament adapted to emit second LED filament light, wherein the first LED filament and the second LED filament are (substantially) parallel, and wherein the first LED filament and the second LED filament are separated by a gap and mechanically connected to each other by a plurality of spacers arranged between the first LED filament and the second LED filament.

The spacers of the present LED filament arrangement provide mechanical stability (for safety purposes) and flexibility, which especially helps to configure the LED filament arrangement in a spiral configuration. In other words, it becomes easier to make a spiral/helix shape (ease of assembly), and the spacers assure keeping a distance over the length of the spiral, which distance is desired for preventing crosstalk, i.e. one filament irradiates and excites a phosphor of the other filament. The human eye is very sensitive to difference in distances of the length of a spiral, especially if the filament arrangement is lit at low intensity, so the present LED filament arrangement with spacers may indeed have improved aesthetics. Furthermore, the spacers could conveniently also be used for making electrical connections. Furthermore, due to the gap, the present LED filament arrangement may have a slim appearance. Furthermore, the gap may give impression of individual LED filaments.

An LED filament, like in the present invention, is providing LED filament light and comprises a plurality of light emitting diodes (LEDs) arranged in a linear array. Preferably, the LED filament has a length and a width, wherein the length is greater than five times the width. The LED filament may be arranged in a straight configuration or in a non-straight configuration such as for example a curved configuration, a 2D/3D spiral or a helix. Preferably, the LEDs are arranged on an elongated carrier like for instance a substrate, that may be rigid (made from e.g. a polymer, glass, quartz, metal, or sapphire) or flexible (e.g. made of a polymer or metal e.g. a film or foil). In case the carrier comprises a first major surface and an opposite second major surface, the LEDs are arranged on at least one of these surfaces. The carrier may be reflective or light transmissive, such as translucent and preferably transparent. The LED filament may comprise an encapsulant at least partly covering at least part of the plurality of LEDs. The encapsulant may also at least partly cover at least one of the first major or second major surface. The encapsulant may not cover one or more e.g. all spacers. The encapsulant may be a polymer material which may be flexible such as for example a silicone. Further, the LEDs may be arranged for emitting LED light e.g. of different colors or spectrums. The encapsulant may comprise a luminescent material that is configured to at least partly convert LED light into converted light. The luminescent material may be a phosphor such as an inorganic phosphor and/or quantum dots or rods. The LED filament may comprise multiple sub-filaments.

The plurality of spacers of the present LED filament arrangement may include at least three spacers, preferably at least five spacers, and most preferably at least seven spacers. In this way, improved mechanical stability may be provided.

The plurality of spacers may be uniformly (+/−0.05 L) distributed along the length L of the LED filament arrangement. This may result in further improved stability.

The plurality of spacers may be arranged away from the ends of the LED filament arrangement. An effect of this is improved appearance, because the arrangement may look like individual LED filaments even though they are connected. The spacer closest to each end of the LED filament arrangement may for example be arranged at least 0.1 L from the end.

The first LED filament and the second LED filament may be mechanically and/or electrically connected to each other by other means than said plurality of spacers at one end or both ends of the LED filament arrangement, for example by electrically conductive wires. Electrically conductive wires will also provide some mechanical fixation. A technical effect of these means is that the electrical function may be separated from the mechanical connection of the spacers.

It is appreciated that the plurality of spacers divide said gap into a plurality of openings each having a length L_{opening} in the length direction of the LED filament arrangement, wherein a width W_{spacer} of each spacer of the plurality of spacers in the length direction of the LED filament arrangement is smaller than said length L_{opening}, and wherein preferably L_{opening}>5 W spacer, more preferably L_{opening}>8 W spacer, and most preferably L_{opening}>10 W spacer. The ratio L_{opening}/W_{spacer} should be large (as claimed) to give the impression that the first and second LED filaments indeed are separated, which in turn provides a better appearance. Preferably, W_{spacer}<3 mm. Furthermore, the width W_{spacer} of each spacer is preferably ≤3 the width W_{filament} of the first and/or second LED filament, more preferably W_{spacer}≤2 W filament, and most preferably W_{spacer}≤1 W_{filament}.

The first LED filament may comprise a first carrier and the second LED filament may comprise a second carrier, wherein the first carrier, the second carrier, and said plurality of spacers are made from a single carrier. The aforementioned plurality of openings may conveniently be made by perforation or punching of the single carrier, while at the same time the plurality of spacers are created. Hence this LED filament arrangement may be easy to manufacture. The single carrier may be a monolithic carrier. The single carrier may for example be a PCB (printed circuit board). The first/second/single carrier may be flexible. Furthermore, the plurality of spacers may be flexible. The spacers may for example comprise or be made of silicone. In another embodiment, the first/second/single carrier may be flexible while the spacers are rigid.

As indicated above, the LED filament arrangement may be arranged in a helix or spiral configuration. The present LED filament arrangement is highly suitable for such a configuration. In a lamp (retrofit light bulb), this LED filament arrangement could be wrapped around a (translucent/transparent/reflective) holder, to fix the helix or spiral configuration. Alternatively, the first/second/single carrier may be a metal core PCB which can be curled to the helix or spiral configuration and is self-supporting.

The plurality of spacers may include at least one spacer per turn of the helix or spiral configuration. This improves stability, and may in particular ensure that said gap between the first and second LED filaments is kept over the complete length of the helix or spiral configuration.

Furthermore, the helix or spiral configuration may have at least three neighboring turns, each of the at least three neighboring turns comprising at least one spacer of said the plurality of spacers. For example if the helix or spiral configuration has five loops/turns, turn 2, 3, and 4 may have a spacer (but not turn 1 and 5).

The first and second LED filaments may have a closest distance CD measured perpendicular to the length of the LED filament arrangement and farthest distance FD corresponding to a (so-called) major groove of the helix or spiral configuration, wherein FD>2CD. In this way, the present LED filament arrangement can look somewhat like a traditional single spiral filament. Hence, there is better spiral look appearance. In another embodiment, FD=CD. Preferably 3 mm<CD<12 mm. This closest distance may indeed prevent crosstalk between the LED filaments. Also preferably, 12 mm<FD<50 mm.

The closest distance CD, which may correspond to a length L_{spacer} of each spacer, could be larger than the width W_{filament} of each of the first and second LED filaments. Preferably L_{spacer}>W_{filament}, more preferably L_{spacer}>1.5 W filament, and most preferably L_{spacer}>2 W_{filament}. Furthermore, the length L_{spacer} of each spacer is preferably <10 the width W_{filament} of the first and/or second LED filament, more preferably L_{spacer}<8 W_{filament}, and most preferably L_{spacer}<5 W_{filament}.

The spacers of the plurality of spacers may be arranged at an angle of 90 degrees with respect to the first and second LED filaments. Alternatively, the spacers may be arranged at an angle different from 90 degrees with respect to the first and second LED filaments. For example when the LED filament arrangement is arranged in the helix or spiral configuration in a lamp, the length axis of the spacers may be parallel to a longitudinal axis of the lamp. In the helix or spiral configuration, the plurality of spacers may also be arranged on only one side of the LED filament arrangement, so that the spacers may be aligned with respect to each other.

Both LED filaments could be adapted to emit e.g. white filament light having the same color temperature. But preferably, the second LED filament is adapted to emit second LED filament light of different color and/or color temperature than the first LED filament light. This gives the possibility to create different colors and/or color temperatures with different LED filaments while it is the same arrangement, e.g. the same carrier.

For example, the first LED filament may comprise white LEDs having a first color temperature, wherein the second LED filament comprises RGB (red green blue) LEDs or white LEDs having a second color temperature different from said first color temperature. The first color temperature CT1 could be <2500K, e.g. 2200K. The second color temperature CT2 could be >2700K, e.g. 3500K. The difference between the second color temperature and the first color temperature could be greater than 500K (CT2−CT1>500K). The RGB LEDs could emit colored (red, green, and/or blue) second LED filament light. The light from the RGB LEDs could also be combined to emit white second LED filament light.

The white LEDs may be blue and/or UV LED light sources/chips encapsulated by a first encapsulant comprising a luminescent material adapted to at least partly convert blue and/or UV LED light into converted LED light. The RGB LEDs may be encapsulated by a second encapsulant which may comprise a light scattering material, to scatter/mix the light and provide a good spatial light distribution.

The LED filament arrangement may further comprise a third LED filament adapted to emit third LED filament light, wherein the third LED filament is parallel to the first and second LED filaments, and wherein the second LED filament and the third LED filament are separated by a gap and mechanically connected to each other by another plurality of spacers arranged between the second LED filament and the third LED filament.

In an exemplary LED filament arrangement with three LED filaments, the first LED filament may comprise white LEDs having a first color temperature, wherein the second LED filament comprises RGB LEDs, and wherein the third LED filament comprises white LEDs having a second color temperature different from said first color temperature. In this way, an LED filament arrangement which can emit both colored light as well as white light with different color temperatures (without crosstalk) is realized. In a preferred embodiment, the three LED filaments are used provide: warm white WW+cool white CW+RGB for colors.

According to a second aspect of the present invention, where is provided an LED filament lamp, comprising at least one LED filament arrangement according to the first aspect, a light transmissive (translucent, preferably transparent) envelope at least partly surrounding said at least one LED filament arrangement, and a connector for electrically and mechanically connecting the LED filament lamp to a socket. The LED filament lamp may for example be retrofit light bulb.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiments of the invention.

FIG. 1 shows a bifilar LED filament arrangement according to an embodiment of the present invention.

FIG. 2 illustrates exemplary steps of manufacturing of the LED filament arrangement of FIG. 1.

FIG. 3 shows a helical/spiral LED filament arrangement according to an embodiment of the present invention.

FIG. 4 shows a “trifilar” (trifilar) LED filament arrangement according to another embodiment of the present invention.

FIG. 5 is a side view of a retrofit light bulb with a helical/spiral bifilar LED filament arrangement according to an embodiment of the present invention.

As illustrated in the figures, the sizes of layers and regions may be exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

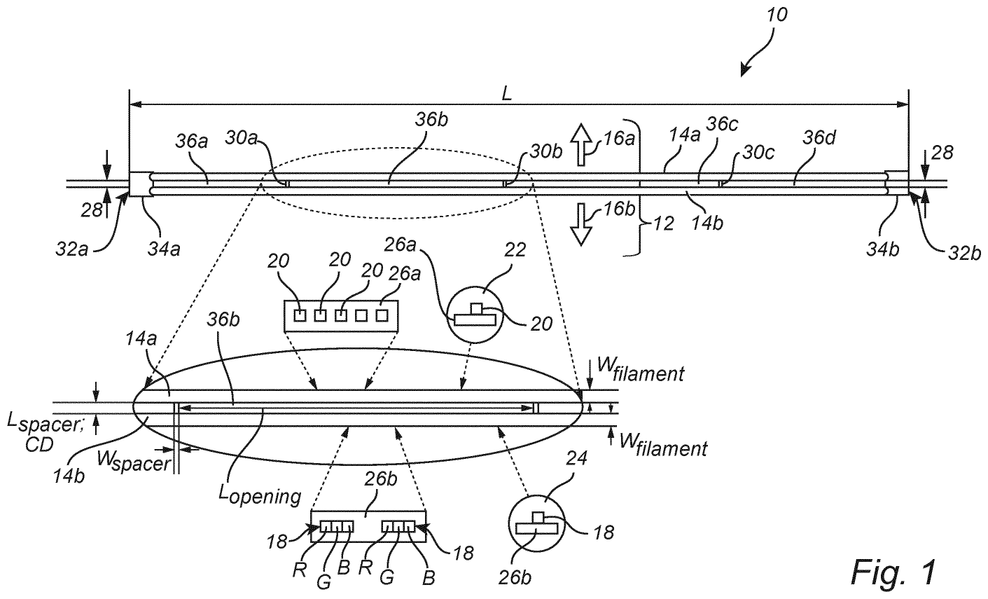

FIG. 1 shows a bifilar LED filament arrangement 10 according to an embodiment of the present invention. The LED filament arrangement 10 is in FIG. 1 arranged in a straight configuration. The LED filament arrangement 10 is generally adapted to provide LED filament arrangement light 12.

The LED filament arrangement 10 comprises a first LED filament 14a and a second LED filament 14b. The first LED filament 14a adapted is to emit first LED filament light schematically illustrated by 16a. The second LED filament 14b adapted to emit second LED filament light schematically illustrated by 16b. The first LED filament light 16a and the second LED filament light 16b may form said LED filament arrangement light 12.

Preferably, the second LED filament 14b is adapted to emit second LED filament light 16b of different color and/or color temperature than the first LED filament light 16a. For example, the first LED filament 14a may comprise white LEDs having a first color temperature, whereas the second LED filament 14b comprises RGB (red green blue) LEDs 18 emitting colored second LED filament light 16b or white second LED filament light 16b having a second color temperature different from said first color temperature. The first color temperature could be <2500K, e.g. 2200K. The second color temperature could be >2700K, e.g. 3500K. The white LEDs may be blue and/or UV LED light sources/chips 20 encapsulated by a first encapsulant 22 comprising a luminescent material adapted to at least partly convert blue and/or UV LED light into converted LED light. The RGB LEDs 18 may be encapsulated by a second encapsulant 24 which may comprise a light scattering material. The second encapsulant 24 may comprise light scattering material(s), such as BaSO₄, Al₂O₃ and/or TiO₂. The first LED filament 14a may further comprise a first elongated carrier 26a on which the blue and/or UV LED light sources/chips 20 are arranged, typically in a linear array. Likewise, the second LED filament 14a may further comprise a second elongated carrier 26b on which the RGB LEDs 18 are arranged, typically in a linear array.

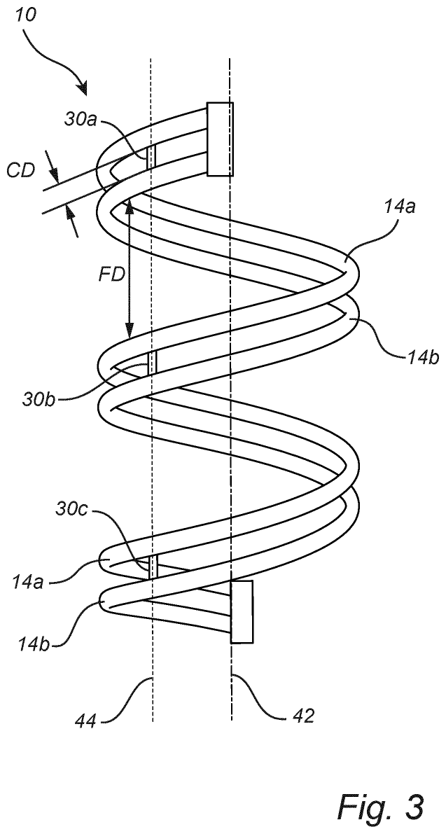

Moving on, the first LED filament 14a and second LED filament 14b are parallel, as shown example in FIG. 1. Furthermore, the first LED filament 14a and the second LED filament 14b are separated by a gap 28 and mechanically connected to each other by a plurality of spacers 30a-c arranged between the first LED filament 14a and the second LED filament 14b. The spacers 30a-c provide mechanical stability (for safety purposes) and flexibility, which especially helps to configure the LED filament arrangement in a spiral configuration (see FIG. 3). Furthermore, the spacers 30a-c assure keeping a distance (gap 28) over the length L of the LED filament assembly 10, which distance/gap 28 is desired for preventing crosstalk, i.e. the second filament 14b irradiates and excites the luminescent material/phosphor of the first filament 14a. Furthermore, due to the gap 28, the present LED filament arrangement 10 may have a slim appearance.

In FIG. 1, the plurality of spacers 30a-c consists of three spacers 30a-c, but the number of spacers could be different, such as five or seven. Also in FIG. 1, the plurality of spacers 30a-c are uniformly distributed along the length L, with one spacer 30b midway along the length L, one spacer 30a midway between spacer 30b and one end 32a of the LED filament arrangement 10, and one spacer 30c midway between spacer 30b and the opposite end 32b of the LED filament arrangement 10. Accordingly, spacer 30a is about 0.25 L from end 32a, and spacer 30c is about 0.25 L from end 32b. Furthermore, at ends 32a-b, the first LED filament 14a and the second LED filament 14b could be mechanically and/or electrically connected to each other, for example by electrically conductive wires or other electrically conductive elements 34a-b. Alternatively or complementary, the spacers 30a-c could be also used for electrical connection(s). For example, a first spacer like spacer 30a may provide a first electrical connection, and a second spacer like spacer 30c may provide a second electrical connection.

The plurality of spacers 30a-c divide the aforementioned gap 28 into a plurality of openings, here four openings 36a-d. Generally, for N spacers there may be N−1 openings between neighboring spacers, as well as two additional openings, one at each end of the LED filament arrangement 10. Each of the openings 36a-d has a length L_{opening} in the length direction of the LED filament arrangement 10. Furthermore, each of the spacers 30a-c has a width W_{spacer} in the length direction of the LED filament 10. The width W_{spacer} of the spacers 30a-c should be small while the length L_{opening} of the openings 34a-d is large. Preferably, L_{opening}>5 W spacer, more preferably L_{opening}>8 W_{spacer}, and most preferably L_{opening}>10 W_{spacer}. Furthermore, the width W_{spacer} of each spacer 30a-c is preferably ≤3 the width W_{filament} of the first and/or second LED filament 14a-b, more preferably W_{spacer}≤2 W_{filament}, and most preferably W_{spacer}≤1 W_{filament}.

Moreover, the length L_{spacer} of each spacer 30a-c, which length L_{spacer} in FIG. 1 is perpendicular to the length L of the LED filament arrangement 10, is preferably <10 the width W_{filament} of the first and/or second LED filament 14a-b, more preferably L_{spacer}<8 W filament, and most preferably L_{spacer}<5 W_{filament}. Furthermore, the width W_{spacer} of each spacer 30a-c is preferably ≤3 the width W_{filament} of the first and/or second LED filament 14a-b, more preferably W_{spacer}≤2 W_{filament}, and most preferably W_{spacer}≤1 W_{filament}.

In an exemplary LED filament arrangement 10, L_{spacer}=8 mm, W_{spacer}=3 mm, and L_{opening}=30 mm.

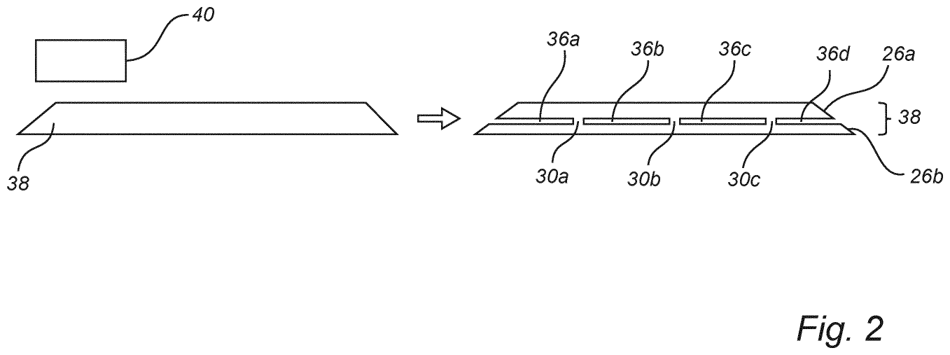

As illustrated in FIG. 2, the plurality of openings 36a-d may conveniently be made by perforation or punching of a single carrier 38 using at least one tool 40. Hence, the first carrier 26a, the second carrier 26b, and the plurality of spacers 30a-c can be made from (by) the single carrier 38. In other words, the spacers 30a-c may be integral with the first and second carriers 26a-b. The single carrier 38 may be a monolithic carrier. The single carrier 38 may for example be a PCB (printed circuit board).

Turning to FIG. 3, FIG. 3 shows a bifilar LED filament arrangement 10 similar to that of FIG. 1, but arranged in a helix or spiral configuration. Here, the first and second carriers of the first and second LED filaments 14a-b of the LED filament arrangement 10 may be a metal core PCB which can be curled to the helix or spiral configuration and is self-supporting.

In the helix or spiral configuration, the plurality of spacers may include at least one spacer per turn of the helix or spiral configuration. The helix or spiral configuration in FIG. 3 has approximately three turns and three spacers 30a-c, hence one spacer per turn.

All the spacers 30a-c may also be arranged on only one side of the LED filament arrangement 10, in FIG. 3 the side facing the viewer.

Furthermore, unlike the spacers in FIG. 1, the spacers 30a-c may here be arranged at an angle different from 90 degrees with respect to the first and second LED filaments 14a-b. In FIG. 3, the spacers 30a-c are parallel to a longitudinal axis 42. Overall, the spacers 30a-c may be neatly aligned with respect to each other, as indicated by dotted line 44.

Moreover, the first and second LED filaments 14a-b may have a closest distance CD and a farthest distance FD. The closest distance CD is measured perpendicular to the length L of the LED filament arrangement 10. The closest distance CD is also shown in FIG. 1. The farthest distance FD corresponds to a so-called major groove of the helix or spiral configuration, and is indicated in FIG. 3. Expressed otherwise, FD is between neighboring turns/loops. One or more of the following may be fulfilled: FD>2CD, 3 mm<CD<12 mm, 12 mm<FD<50 mm, and CD>W_{filament}.

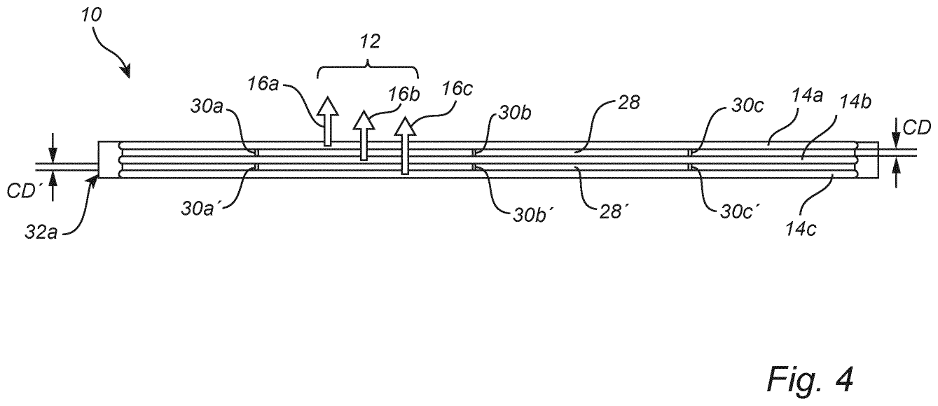

In FIG. 4, the LED filament arrangement 10 further comprises a third LED filament 14c, but may otherwise be similar to the LED filament arrangement 10 in FIG. 1. The third LED filament 14c is parallel to the first and second LED filaments 14a-b. Furthermore, and the second and third LED filaments 14b-c are separated by another gap 28′ and mechanically connected to each other by another plurality of spacers 30a′, 30b′, 30c′ arranged between the second and third LED filaments 14b-c. A closest distance CD′ between the second LED filament 14b and the third LED filament 14c could be the same as, or different than, the aforementioned closest distance CD. Furthermore, the other plurality of spacers 30a′, 30b′, 30c′ may be configured (#numer, size/dimensions, and/or position) in the same way as, or differently than, the spacers 30a-c.

The third LED filament 14c is adapted to emit third LED filament light schematically illustrated by 16c. The first LED filament light 16a, the second LED filament light 16b, and the third LED filament light 16c may form LED filament arrangement light 12. The third LED filament light 16c may be different with respect to color and/or color temperature than the first and second LED filament light 16a-b. For example, the first LED filament 14a may comprise white LEDs having a first color temperature, the second LED filament 14b may comprise RGB LEDs emitting colored second LED filament light 16b, whereas the third LED filament 16c may comprise white LEDs having a second color temperature different from the first color temperature. The first color temperature could be <2500K, e.g. 2200K. The second color temperature could be >2700K, e.g. 3500K.

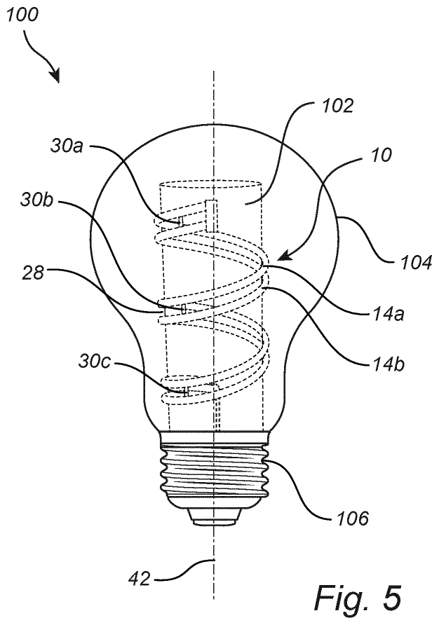

FIG. 5 shows an LED filament lamp 100, namely a retrofit light bulb. The lamp 100 comprises a bifilar LED filament arrangement 10 in a helix or spiral configuration. The LED filament 10, which otherwise may be similar to that of FIG. 3, is here wrapped around a transparent holder 102 of the lamp 100, to fix the helix or spiral configuration. The transparent holder 102 may have the shape of right circular cylinder.

The lamp 100 further comprises a transparent envelop 104 surrounding the LED filament arrangement 10. The envelop 104 is preferably made of glass. The envelop 104 may have various shapes. The lamp 100 further comprises a threaded connector/cap 106 for electrically and mechanically connecting for the lamp 100 to an external socket (not shown). The connector/cap 106 can be of various types known per se, for example E26 or E27.

The lamp 100 may further comprise a controller (not shown) for individually controlling the LED filaments of the LED filament arrangement 10.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An LED filament arrangement providing LED filament arrangement light, comprising:
a first LED filament adapted to emit first LED filament light; and
a second LED filament adapted to emit second LED filament light,
wherein the first LED filament and the second LED filament are parallel, and wherein the first LED filament and the second LED filament are separated by a gap and mechanically connected to each other by a plurality of spacers arranged between the first LED filament and the second LED filament,
wherein said plurality of spacers includes at least three spacers, preferably at least five spacers, and most preferably at least seven spacers, and
wherein the first LED filament comprises a first carrier and the second LED filament comprises a second carrier, and wherein the first carrier, the second carrier, and said plurality of spacers are made from a single carrier.

2. An LED filament arrangement according to claim 1, wherein said plurality of spacers are uniformly distributed along the length of the LED filament arrangement.

3. An LED filament arrangement according to claim 1, wherein said plurality of spacers are arranged away from the ends of the LED filament arrangement.

4. An LED filament arrangement according to claim 1, wherein the first LED filament and the second LED filament are mechanically and/or electrically connected to each other by other means than said plurality of spacers at one end or both ends of the LED filament arrangement.

5. An LED filament arrangement according to claim 1, wherein the plurality of spacers divide said gap into a plurality of openings each having a length L_{opening} in the length direction of the LED filament arrangement, wherein a width W_{spacer} of each spacer of the plurality of spacers in the length direction of the LED filament arrangement is smaller than said length L_{opening}, wherein preferably L_{opening}>5 W_{spacer}, more preferably L_{opening}>8 W_{spacer}, and most preferably L_{opening}>10 W_{spacer}.

6. An LED filament arrangement according to claim 1, arranged in a helix or spiral configuration.

7. An LED filament arrangement according to claim 6, wherein the plurality of spacers includes at least one spacer per turn of the helix or spiral configuration, and/or wherein the helix or spiral configuration has at least three neighboring turns, each of the at least three neighboring turns comprising at least one spacer of said the plurality of spacers.

8. An LED filament arrangement according to claim 6, wherein the first and second LED filaments have a closest distance CD measured perpendicular to the length of the LED filament arrangement and farthest distance FD corresponding to a major groove of the helix or spiral configuration, and wherein FD>2CD.

9. An LED filament arrangement according to claim 1, wherein the second LED filament is adapted to emit second LED filament light of different color and/or color temperature than the first LED filament light.

10. An LED filament arrangement according to claim 1, wherein the first LED filament comprises white LEDs having a first color temperature, and wherein the second LED filament comprises RGB LED or white LEDs having a second color temperature different from said first color temperature.

11. An LED filament arrangement according to claim 1, further comprising a third LED filament adapted to emit third LED filament light, wherein the third LED filament is parallel to the first and second LED filaments, and wherein the second LED filament and the third LED filament are separated by a gap and mechanically connected to each other by another plurality of spacers arranged between the second LED filament and the third LED filament.

12. An LED filament arrangement according to claim 1, wherein the second LED filament comprises RGB LEDs, and wherein the third LED filament comprises white LEDs having a second color temperature different from said first color temperature.

13. An LED filament lamp, comprising:
at least one LED filament arrangement according to claim 1;
a light transmissive envelope at least partly surrounding said at least one LED filament arrangement; and
a connector for electrically and mechanically connecting the LED filament lamp to a socket.
